(19) United States
(12) Patent Application Publication
(10) Pub. No.: US 2016/0021842 A1
(43) Pub. Date: Jan. 28, 2016

(54) MECHANICAL MILKING SYSTEM, DEVICE, PROCEDURE AND USE FOR DAIRY ANIMALS THAT ALLOWS INHIBITING, AND/OR PREVENTING THE PRESENCE OF INFECTIONS DUE TO MASTITIS, WITH SURFACE FUNGICIDE, ANTIBACTERIAL, ANTIVIRUS, AND MICROBICIDE PROPERTIES, WHEREIN THE SURFACE COMPRISES SPECIFIC SURFACE RUGOSITY FORMED BY A SPECIAL ALLOY WITH COPPER CONTENT MOSTLY

(71) Applicants: Willi FUCHS, (US); David PINTO DíAZ, (US); Alberto NÚÑEZ NEUMANN, (US)

(72) Inventors: David PINTO DíAZ, Ñuñoa - Santiago (CL); Alberto NÚÑEZ NEUMANN, LOS ÁNGELES Región del Bíobío (CL)

(21) Appl. No.: 14/773,512

(22) PCT Filed: May 17, 2013
(86) PCT No.: PCT/EP2013/060250

§ 371 Date: Sep. 8, 2015

(30) Foreign Application Priority Data
Mar. 8, 2013 (CL) 201300649

(51) Int. Cl. A01J 7/04; A01J 9/02; A01J 5/04

(52) U.S. Cl. CPC A01J 7/04; A01J 5/047; A01J 9/02; A01J 5/044

(57) ABSTRACT

This invention is related to a pneumatic mechanical milking system (1) for a dairy animal that allows reducing, inhibiting, and/or preventing infection by mastitis, with fungicide, anti-bacteria, anti-virus, and microbicide surface properties, wherein the system comprises at least one device (2) that connects the animal udder (3), that defines a cylindrical shape (4), where the said device defines different openings at its corresponding ends, an upper opening (5) of a larger diameter through which end the dairy animal udder is introduced, a lower end (6) with a smaller diameter, comparable to the upper end through which milk is extracted, and a lower angular end (7) of small diameter, formed by an expanded tubular section (8) connecting the system air supply, wherein said device (2) entire surface has a rugosity quality within a specific range and it is formed by a special alloy containing at least 50% copper; at least one extended membrane (9) in the sense of its main axis, with an upper end (10) with a lip (11) that externally fits into the device (2) upper opening (5), and a lower end (12) that goes through the device lower end (6) opening; a milk collector (13) that includes a cover (14) provided with at least four entries (15, 16, 17, 18), where at least one of the said entries connects with the expanded membrane lower end (12), wherein said cover also includes at least four air intakes (19, 20, 21, 22); the said collector and cover entire surface have a surface rugosity quality within a specific range, and the said surface is formed by a special alloy with at least 50% copper content; and at least one longitudinal connector (23) to channel air which, at the one end (24) connects the device (2) extended tubular section (8) and, on the other end (25), it connects a collector (13) air intake. The invention also includes a procedure to implement the said pneumatic mechanical system to milk a dairy animal, as well as the use of the said mechanical system and device in traditional and/or organic dairy plants.

### FIELD OF THE INVENTION

This invention refers to a pneumatic mechanical milking system for dairy animals that allows reducing, inhibiting, and/or preventing the presence of infections due to mastitis, wherein the entire surface of said system includes a specific surface rugosity formed by a special alloy with at least 50% copper content which, together, grant fungicide, antibacterial, antivirus, and microbicide properties to the surfaces in contact with pathogen micro-organisms present in mastitis. The invention also includes a milking device, part of the said milking system, which mechanically supports an extended membrane internally lodged in the device. The device presents, in its entire surface, a specific surface rugosity quality, with a special alloy containing at least 50% copper which, as a whole, grant fungicide, antibacterial, antivirus, and microbicide surface properties. This invention also includes a procedure to implement the said pneumatic mechanical system to milk a dairy animal, as well as the use of the said mechanical system and device in traditional and/or organic dairy plants.

### INVENTION BACKGROUND

Milk consumption goes beck many years, when nomad humans began farming and milking their animals in order to obtain food.

The first animals to be milked were sheep and goats, and later consumption of cow's milk and its derivatives was added.

Milk preservation was a great problem in those years. One of the preservation methods was the reduction of water contents, minimizing possible bacteria reproduction in milk, and adding sugar to increase its preservation and useful life, as well as hygiene.

The most important preservation method was that discovered by Louis Pasteur, which received his name. The method is the elimination of bacteria through heat, which guaranteed the destruction of pathogens in milk regarding their number and expansion possibilities.

Later, in the 20^{th} Century, sterilization and ultra-pasteurization or UHT (Ultra High Temperature) were discovered which, in addition to offering the same effects as pasteurization, also eliminates spores, and food can be kept at room temperature.

Currently, the world high milk demand has led to the replacement of traditional milking methods with large industrialized and automated systems, going from the milking of a single animal, to a giant dairy herd or group of animals that live and are fed every day according to the amount of milk each one of them is able to produce.

In general terms, in order to obtain milk it is necessary to milk the animal, which may be a sheep, cow, goat, or other, mainly with mechanical methods by connecting the animal udder to automatic milking machines that extract milk. Then, milk is stored in stainless steel containers, from which the processor purifies it and eliminates solids that may be found in the product through a pasteurization process.

These containers not only purify milk, but also keep it cold for a better preservation. Later, the companies collect the milk and transport it to plants for industrialization and the preparation of side products in different presentation (condensed, evaporated, skim, lactose-free, flavored, etc.), as well as cheese, cream, yoghurt, etc.

The food industry uses different methods to preserve milk during extended periods, trying not to affect its nutritional value, color, taste, and smell.

One of the great current challenges in these industrialized milk production systems is milk quality, mainly its safety.

Milk consumers mainly demand dairy products to be safe, that milk should come from healthy animals, to have certain nutritional value, and that the milked animal enjoys acceptable animal welfare conditions during the milking process.

Being safety understood as the certainty that food will not harm the consumer health, it is also understood that innocuousness is determinant in food safety.

Elements determining safety in non-sterilized milk are:
1) Level of mastitis in the milked animal group
2) Inhibitors
3) Bacteria contamination
4) Iodine and other chemical contaminants
5) Other elements such as pesticides, etc.

In order to determine mastitis level, the variable called somatic cell count (SCC) is used, which measures milk innocuousness and safety, and its suitability for human consumption, on the one hand and, on the other hand, it measures mastitis level in the animal group, such as the animal—infected udder ratio. The SCC variable is an important indicator used by the industry regulatory entities.

As regulatory limit, SCC establishes the maximum amount of abnormal or unsafe milk in a certain milk batch or delivery.

In countries with a long dairy production tradition, such as New Zealand, Norway, and Switzerland, as well as the European Union, the current regulatory limit is 400,000 somatic cells per milliliter (cells/ml). In other places there is a different limit, as in the United States, where the SCC limit is 750,000 (cells/ml) and in Canada it is 500,000 (cells/ml).

Currently, the USA 750,000 limit is being reviewed by the industry supervising entities, and a limit not higher than 400,000 (cells/ml) is foreseen.

In other jurisdictions, as in Chile for instance, there is no formal limit established by the corresponding authority; there is only a reward or penalty applied to the milk producer by the processing and marketing industries, depending on the delivered milk safety degree.

The most general purpose of this invention is to solve the lack of safety in milking farms, specifically and with no restrictions, in organic milking farms, in order to get milk with a higher safety standard.

In order to get higher safety standard milk it is necessary to place the milking farm at an acceptable safety level by addressing and controlling variables such as feeding, handling, hygiene, milked animal disease control, as well as training the personnel involved in production on hygiene and procedures used. This will result in food not representing a risk for consumer health.

Considering the need to guarantee food safety, especially milk, it is necessary to consider every segment in the food chain, where each element may potentially affect the product safety, making the application of the “safety from the farm to the table” principle possible.

Based on the above, this invention addresses the strengthening of safety in milk production by addressing the most important factors in the production chain, such as interaction in the milking farm, specifically and with no restrictions, in the milking room, where personnel who participate in the assembly and handling of milking systems, especially in the installation of at least one milking device in the animal udder, and in cross-handling with the animal, as well as with the rest of dairy animals to be milked.

### Mastitis

Milk safety is generated in primary production and it includes, among other, animal health, treatment with veterinarian drugs, milking and storage hygiene, and milk preservation at the farm.

Pathogen micro-organisms most frequently causing mastitis may be divided in two groups, based on their origin: environmental pathogens and contagious pathogens. The main contagious pathogens are Streptococcus Agalactiae (S. Agalactiae), Staphylococcus Aureus (S. Aureus), and Mycoplasma spp.

Except for some mycoplasma infections that may originate in other parts of the dairy animal body and systematically spread, these three organisms enter the mammary gland through the nipple channel. Contagious organisms are well adapted to survive and grow in the mammal gland, and they frequently cause infections that last weeks, months, or years. The infected gland is the main source of these organisms in a dairy herd or group, and transmission of contagious pathogens between udders and other non-infected dairy animals mainly occurs during milking.

### Streptococcus Agalactiae (S. Agalactiae)

S. Agalactiae is a mandatory parasite in the mammary gland, which means that, in nature, it can only live and reproduce in the mammary gland. Due to this host-parasite relation, S. Agalactiae can be controlled and eradicated from a dairy herd or group by identifying and treating infected animals. This may be done by obtaining milk samples from all the dairy herd or group animals for bacteriologic cultivation, and treating udders infected with S. Agalactiae with the correct intra-mammary infusion. Infections by S. Agalactiae respond well to preparations for intra-mammary mastitis based on beta-lactone in dairy animals in production as well as in dry status. Use of other types of antibiotics generally results in poor cure rates. Some chronic infections are not recovered, and slaughtering these animals should be considered in order to prevent infecting others.

Once S. Agalactiae is eliminated from a daily herd or group, strict control measures should be applied in order to prevent re-infection; milk in the tank should be monitored through monthly cultivation for at least six months, in order to guarantee the disease complete elimination. It is necessary to keep the herd or group confined in order to keep them free from this pathogen. Outbreaks usually occur due to the acquisition of infected animals or from the use of milking equipment or mechanical systems that have been contaminated by other animals or during animal shows. New animals entering the herd must be sampled before putting then together with the rest of the herd or group.

The following is a description of the most relevant intra-mammary infection characteristics, present in dairy animals and largely responsible for the produced milk safety.

Staphylococcus Aureus (S. Aureus) S. Aureus is the hardest bacteria to eradicate, but it is clearly controllable. Infected udders are the most important source of infection. This micro-organism colonizes well in the nipple skin injuries and channel, and then goes inside the mammary gland. The micro-organism is also able to survive in other parts of the dairy animal body. Mastitis caused by S. Aureus damages the milk-producing tissue even more than other pathogens such as S. Agalactiae, and reduces milk production in dairy animals, such as cows, where 45% loss per quarter and 15% production loss has been reported in infected cows. Slight and recurrent clinical mastitis signs cause additional losses. In mastitis from S. Aureus, bacteria count in milk tanks is not generally high; however, as the number of infected dairy animals increases, the SCC number in the tank milk increases, resulting in milk quality reduction. Herds whose milk tank SCC level exceeds 300,000 to 500,000 cells/ml frequently have a high number of udders infected with S. Aureus.

The bacteria harms the duct system and causes infection in deep points of the milk secreting tissue, where later abscesses are formed and bacteria is encapsulated in cicatrized tissue. This cicatrized tissue encapsulating phenomenon is partially responsible for the poor healing rate of infections caused by S. Aureus and treated with antibiotics.

During the infection initial stage, damage is minimal and reversible. However, abscesses may release staphylococci that start the infection process in other areas of the gland, forming more abscesses and causing irreversible damage to the tissue. Occasionally, infections by S. Aureus may cause hyper acute mastitis with gangrene. This gangrene mastitis is characterized by discoloration in bluish patches and coldness in the affected tissue.

In order to prevent intra-mammary infections by S. Aureus, it is necessary to limit the spreading of this organism from one dairy animal to other and reduce to the minimum the number of infected animals in the herd or group. In order to reach these objectives, milk from infected animals should never be in contact with non infected animals. For this reason, animals infected with S. Aureus must be identified and milked last, or in a unit different from that where non infected animals are milked.

In order to reach a “S. Aureus-free status”, all infected dairy animals must be identified and handled as described above. The “non-infected” herd or group must be carefully monitored through individual SCC and milk culture.

### Stainless Steel in the Dairy Industry

In the dairy industry, as well as in the majority of food Industry, stainless steel has been used for many years, in different varieties, as the safest metal for food use.

This metal is present in animal milking, in the milking room, in cold storage, in milk collection and transportation to processing and distribution plants, as well as in the entire production chain linked to side products.

In fact, when the dairy animal is milked, milk is at approximately 36° C., for which reason it must be quickly refrigerated in order to reduce temperature to approximately 4° C. In a period no longer than three hours, in order to prevent and block bacteria present on the surface.

Currently, every accessory, such as milking devices, milk collectors, storage tanks, transportation ducts, valves, etc. used in the animal milking are generally made of AISI 304-type stainless steel.

Finishing or surface quality used in this equipment and accessories vary from polished health finishing with no welding and ground finishing.

In other side industries, such as those producing butter, different types of equipment are used, such as centrifugal cream separators with rotors made of martensitic stainless steel of the AISI 431 type, or austenitic and ferritic steel of the AISI 329 type.

Although stainless steel has high resistance to corrosion, which largely reduces milk contamination risks, it has a significant disadvantage regarding bacteria and strain adherence to surface. In this context, surface adherence of a bacteria and strain group on stainless steel is high, and among them there are those causing mastitis, as Staphylococcus Aureus (MRSA), Streptococcus Agalactiae, Strepococcus dysgalactiae, Klebsiella pneumonlae (gram negatim), Acinetobacter baumanni, Streptococcus Uberis, among other.

The situation described above creates a bacteria accumulation and adherence problem on stainless steel surfaces where, together with the difficulties to remove and eradicate them from the said surfaces, these bacteria grow and increase their count in a short period in an exponential way.

This phenomenon is increased by the surface rugosity quality used with the metal.

This invention attempts to address and provide solutions to the above described problems by developing a pneumatic mechanical system to milk a dairy animal, formed by a device and milk collector whose surfaces are made from a special alloy with at least 50% copper content where, together with the said alloy specific surface rugosity quality, it is possible to reduce, inhibit, and/or prevent infection from mastitis, considering its fungicide, antibacterial, and microbicide qualities provided by copper which, together with reducing bacteria surface adherence to microscopic grooves on the alloy surface, due to its specific surface quality.

### Surface Quality and Adherence

In a strict sense, “finishing or surface quality” may be defined as a diversion from the ideal flat surface. This diversion is normally expressed in terms of rugosity (Ra) and waviness.

A smooth surface with high resistance to cracking, chipping, flaking, and abrasion should not only resist contaminant accumulation, but it should also be easy to clean. In this context, there is a large variety of stainless steel to choose from, as well as several surface finishing types, especially for the food industry, and specifically for the dairy industry.

The decision on which type of steel is the most appropriate for a certain purpose is mainly based on the working means aggressiveness. However, the surface quality (finishing) also affects the capacity to stand corrosion and the ability to reject dirt and bacteria.

Then, the risk of cross-contamination also increases as stainless steel rugosity increases; therefore, having a copper alloy with an improved surface rugosity directly contributes to higher hygiene on the metal surface in direct contact with the mechanical milking system operator handling. It also contributes to decrease cross-contamination between the dairy animal, metal surfaces, and human handling.

### Milking Process

Transmission of pathogens causing contagious mastitis from an infected dairy animal to other, non-infected farm animal generally occurs during the milking cycle. Important factors in contagious pathogen transmission include the milking machine and its components, the milker hands, wash materials for dairy animal udder washing, and treatment procedures.

Spreading of contagious pathogens may be significantly reduced with a good hygiene of the udder and the sealing of nipples after milking.

Other handling factors that may cause sensitivity in pathogens causing mastitis, including those causing contagious mastitis, are:

Injuries: The nipple healthy skin is the first defense line against mastitis. Injuries in the nipple skin frequently contain bacteria that may cause mastitis. The cause for nipple skin injuries must be identified and eliminated fast. In cold weather, the nipple skin freezing and cracking is an injury, and it has been demonstrated that such injuries tend to present S. Aureus.

Nutrition: In many parts of the world, including Chile, soil lacks selenium and, therefore, food growing in this soil will lack the said metal. On the other hand, vitamin A and E content of feed in silos decreases during storage. In this context, research indicates that diets with poor vitamin A and E or selenium and copper content tend to increase the occurrence of mastitis.

Milking system: The pneumatic mechanical system and its devices used in milking can also affect the new, contagious, mastitis infection rate due to mechanic components becoming bacteria transporting sources to non-infected dairy animals. This may be minimized by segregating and milking dairy animals infected with a high SCC rate last.

Also, during milking of an infected animal udder, bacteria may be transferred to a non-infected udder of the same animal through the milk collector. On the other hand, cross-infections may occur in up to 40% of new infections in some dairy animal herds and/or groups. Then, the milking equipment correct design and operation prevents air and milk drops transfer from one udder to the other, reducing those infections.

A sudden reduction in the milking vacuum may cause air to move to the tip of the nipple, and milk drops may hit the nipple tip. If drops are contaminated with bacteria, the impact could force the bacteria to the nipple channel, and increase the new infection rate. Research has shown that high rates of new infections are associated to vacuum fluctuations only when accompanied with the milking devices sliding, a condition generally known as impacts to the nipple tip.

Contagious organisms, whose primary source is the dairy animal mammary gland, are mainly transferred by events associated to milking. Good milking procedures, including nipple cleanliness and hygiene during milking and their sealing after milking, reduce the infection spreading from an infected dairy animal to a non-infected one. In herds or groups not infected with mycoplasma, use of rubber or plastic gloves during milking is highly recommended. Gloved hands should be disinfected between animals and dried with disposable paper towels. Some research tests have indicated an additional control of contagious pathogens through the automatic disinfection of collectors (backwash) or by submerging collectors in a disinfectant solution between animals. However, in traditional dairy farms this practice is difficult to control, and it is believed that it has had a minimum effect on the reduction of new infections rate, especially when compared to a correct nipple sealing after milking.

Based on the above, this invention also addresses a new dairy animal milking process in order to implement a pneumatic mechanical system that includes the following steps:
a) Wearing completely clean clothes by the pneumatic mechanical milking system handler. This shall include wearing gloves in both hands and a mouth protector
b) Before connecting the mechanical milking system, it is necessary to clean each dairy animal udder with clean disposable paper, avoiding to re-use it to clean the animal other udders and udders of other dairy animals;
c) Applying udder disinfectant;
d) After some minutes, cleaning the each seal of the dairy animal udders with paper, which may contain disinfectant or aloe vera. Cleaning should be done as described in step b);
e) Installing the mechanical milking system to the animal to be milked, placing at least one device used in the system on the dairy animal udder;
f) Once the said udder milking is completed, and the pneumatic mechanical milking system has been removed, an udder sealer should be applied in order to generate a physical barrier against infections until the next milking.

This invention deals with a pneumatic mechanical milking system for a dairy animal that allows solving the above described problems, where the said system includes, on its entire surface, a specific surface rugosity quality also formed by a special alloy with at least 50% copper content which, together, grant fungicide, anti-bacteria, anti-virus, and microbicide properties to contact surfaces. The invention also includes a milking device, part of the said milking system, which mechanically supports an extended membrane lodged inside the said device. Furthermore, in its entire surface, the device presents a specific rugosity quality, made of a special alloy of at least 50% copper content, which together grant fungicide, anti-bacteria, anti-virus, and microbicide surface properties. This invention also includes a procedure to implement the said pneumatic mechanical system to milk a dairy animal. The invention also includes the use of the said mechanical system and the device in traditional and/or organic dairy farms.

### DESCRIPTION OF FIGURES

FIG. 1: It shows a scheme of the pneumatic mechanical milking system preferential embodiment installed on the dairy animal.

FIG. 2: It shows a preferential embodiment of the device forming part of the invention.

FIG. 3: It schematically shows the extended membrane connection with the device and longitudinal connector, which communicates air/vacuum between the collector and the device.

FIG. 4: It schematically shows a preferred embodiment for the milk collector used in the invention system.

FIG. 5: This figure schematically shows how Ra surface rugosity is measured.

FIG. 6: This figure shows the surface adherence occurring between the Escherichia Coil bacteria (B) and the stainless steel surface (A), magnified at 200%.

FIG. 7: This figure provides an scheme on the relation between the used alloy surface rugosity quality (Ra) and the size of the corresponding bacteria (d), which directly and negatively, or positively, affects cleaning of the corresponding surface to make it bacteria-free.

FIG. 8: This figure shows a laboratory test carried out at Universidad Austral de Chile in November 2011, where Staphylococcus Aureus (C) bacteria was cultured on the entire plate surface; a small disc made of the alloy used in the invention was placed on it (D).

FIG. 9: In this figure, which corresponds to a FIG. 8 close up, the halo (E) generated around the disc made of the alloy used in the invention may be dearly seen. It shows the power and effect generated by the alloy on the S. Aureus bacteria present in mastitis.

### DETAILED DESCRIPTION OF PREFERRED REALIZATIONS

This invention describes a pneumatic mechanical milking system (1) for a dairy animal that allows reducing, Inhibiting, and/or preventing the presence of Infection by mastitis with fungicide, antibacterial, anti-virus, and microbicide surface properties, as mentioned above.

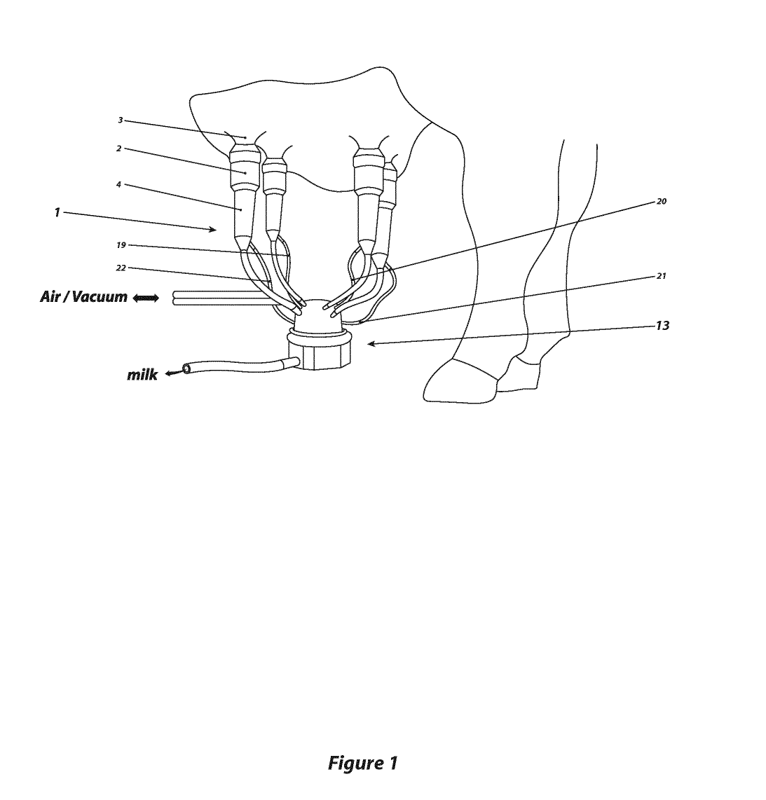

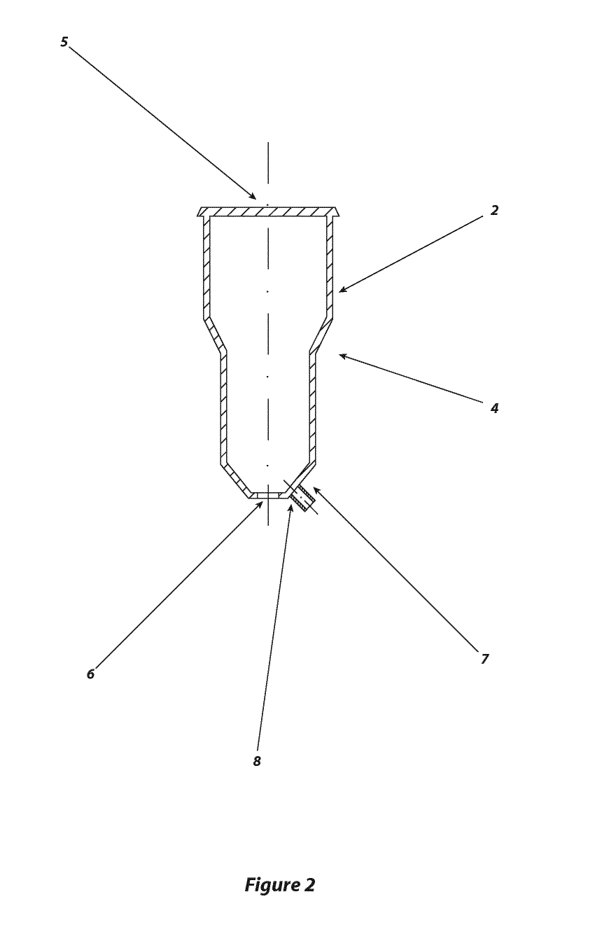

In this context, and depending on the dairy animal to be treated, such as a cow, the invention system includes, as shown in FIG. 1, at least one device (2) and/or one device per udder, wherein in a preferred embodiment of the invention there are at least four devices (2) to be connected to each udder of the animal (3). The said device defines a cylindrical geometry (4), which in one embodiment includes narrowing, where the said narrowing is located in the middle section of the cylindrical shape. The invention device, as shown in FIG. 2, defines different openings in its corresponding ends, an upper opening (5) with a larger diameter through which end the dairy animal udder is introduced, a lower end (6) with a smaller diameter opening compared to the upper end, through which milk is extracted, and an angular lower end (7) with a small diameter opening, where the said and is formed by an extended tubular section (8) through which air supply is connected to the system.

In addition, the device (2) includes a surface rugosity quality in its entire surface (Ra) within a specific range, where the said surface is formed by a special alloy with at least 50% copper content, in addition to zinc, silicon, and phosphorous. On the other hand, and in one invention embodiment, the device includes a surface rugosity quality (Ra) within a range of 0.5 to 1 [μm].

In another embodiment of the invention, the device middle section narrowing defined by circumferential geometry includes a curvature radius from 8 to 10 [mm]; where narrowing includes a curvature range preferably between 8.5 and 9.5 [mm], which is even more preferably than 9.2 [mm].

On the other hand, the device lower end includes a curvature radius from 8 to 12 [mm], being the said curvature radius preferably in from 9 to 11 [mm], preferably 10 [mm], and most preferably 10.5 [mm].

With regard to the device wall thickness, this is from 1 to 2.5 [mm], preferably from 1.2 to 1.8 [mm], a preferably thickness of 1.2 [mm], and most preferably 1.5 [mm].

On the other hand, as shown in FIG. 3, the Invention system also includes at least one extended membrane (9) in the sense of its main axis, a milk collector (13), and at least one air channeling longitudinal connector (23).

In this context, at least one extended membrane (9) has an upper end (10) with a lip (11) that externally fits into the upper opening (5) of the device (2), and a lower end (12) that goes through the said device lower end opening (6). In an embodiment of the invention, the extended membrane (9) is formed by a resilient material, which allows expanding and contracting the corresponding wall when mechanically necessary due to pressure differentials present at the air input through the angular lower end (7), and where, in an embodiment of the invention, the extended membrane includes a cavity or fitting lodged in the entire lip perimeter, which allows a tight fitting with the device upper opening.

Furthermore, in an embodiment of the Invention the extended membrane also includes a notch ring proportional to the device lower opening diameter; the said configuration has a right fitting between the extended membrane and the device lower opening, which allows rigid fixing and a surface stress level on the membrane wall enough to generate the expansion and contraction effect when milking the dairy animal.

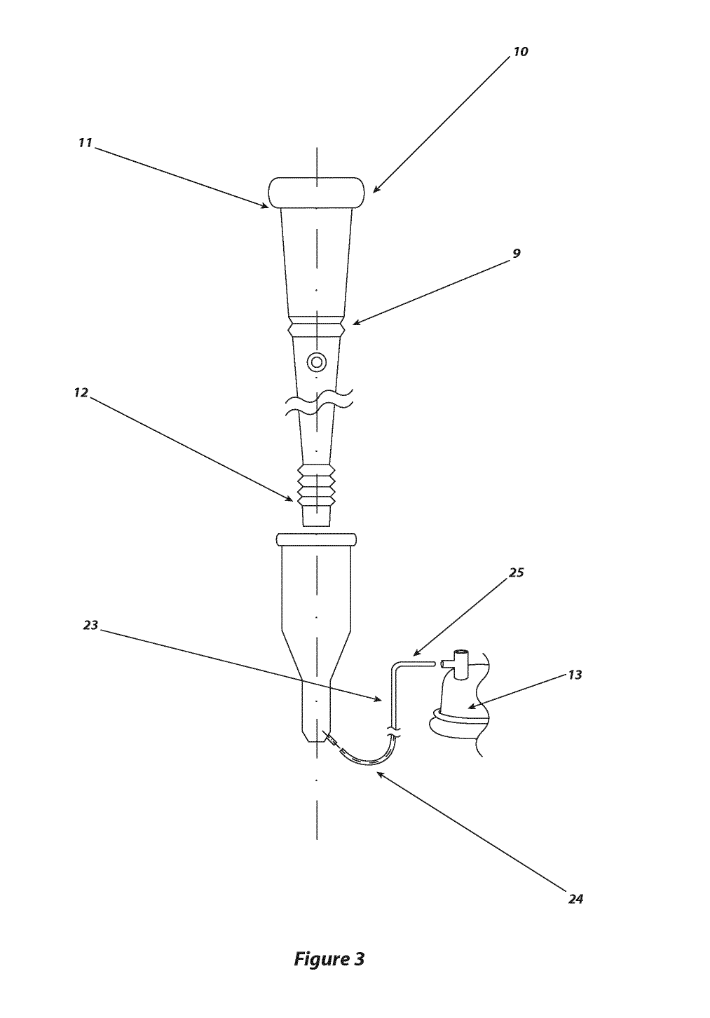

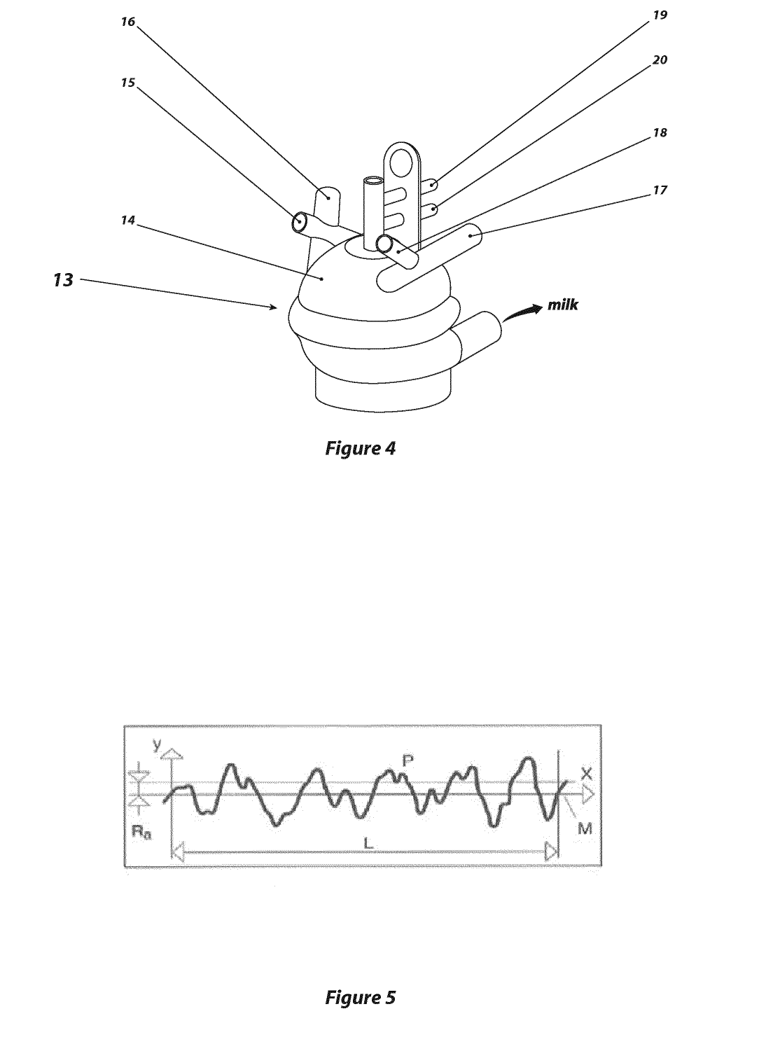

On the other hand, the milk collector (13), as shown in FIG. 4, includes a cover (14) provided with at least four entries (15, 16, 17, 18), where at least one of the said entries is connected to the extended membrane lower end (12); the said cover also includes at least four air intakes (19, 20, 21, 22), as shown in FIG. 1, where the said collector and its cover include in their entire surface a surface rugosity quality (Ra) within a specific range. The said surface is also formed by a special alloy with at least 50% copper content. In an embodiment of the invention, the collector surface (13) alloy is formed by at least 50% copper content, in addition to zinc, silicon, and phosphorous. On the other hand, in an embodiment of the invention, the collector has a surface rugosity quality (Ra) within the 0.5 to 1 [μm] range.

In an embodiment of the invention, the cover surface (14) is made of an alloy mainly made of copper, in addition to zinc, silicon, and phosphorous. On the other hand, in an embodiment of the invention, the collector cover (13) includes at each entry a configuration that is substantially tangential to the cover wall, tilted downwards. Also in connection with the cover (14), in an embodiment of the invention, the cover (14) geometric configuration is frustoconical, with each entry placed in a generally rectangular distribution.

Finally, at least one longitudinal connector (23) channeling air connects, at one end (24), to the device (2) extended tubular section (8), and at the other end (25) it connects to a collector (13) air intake, as shown in FIG. 3.

In an embodiment of the Invention, the device upper end includes a lip or flange along its entire perimeter in order to facilitate fitting to the extended membrane lip, where the lip or flange length is between 3.5 and 5 [mm], and the curvature radius is between 1.8 and 2.5 [mm]. In certain embodiment the said lip or flange includes a ribbed surface.

In connection with the device angular lower end, this is formed by a straight or curve extended tubular section. The straight extended tubular section has 8 [mm] external diameter, is 24.4 [mm] long, and its wall is from 1.2 to 1.5 [mm]thick, where the straight extended tubular section, in its farthest end, is 10 [mm] long, its external diameter is 9 [mm], and its inclination angle is 25 degrees from the device main axis. Furthermore, the straight extended tubular section is joined to the device body through 2 [mm] wide bead welding applied on the entire perimeter. On the other hand, the curve extended tubular section may have a curvature radius from 25 to 30 [mm], where the said curvature farthest end is 10 [mm] long, with 9.4 [mm] external diameter, an extended tubular section total length of 29 [mm], and 1.2 to 1.5 [mm] wall thickness. The curve extended tubular section is joined to the device body with 2 [mm] wide bead welding applied on the entire perimeter.

In connection with the paragraphs above, in an preferential embodiment of the Invention, the alloy used for the above mentioned devices, whose main component is copper combined with other components, presents a surface with fungicide, and/or anti-bacteria, and/or anti-virus, and/or microbicide characteristics.

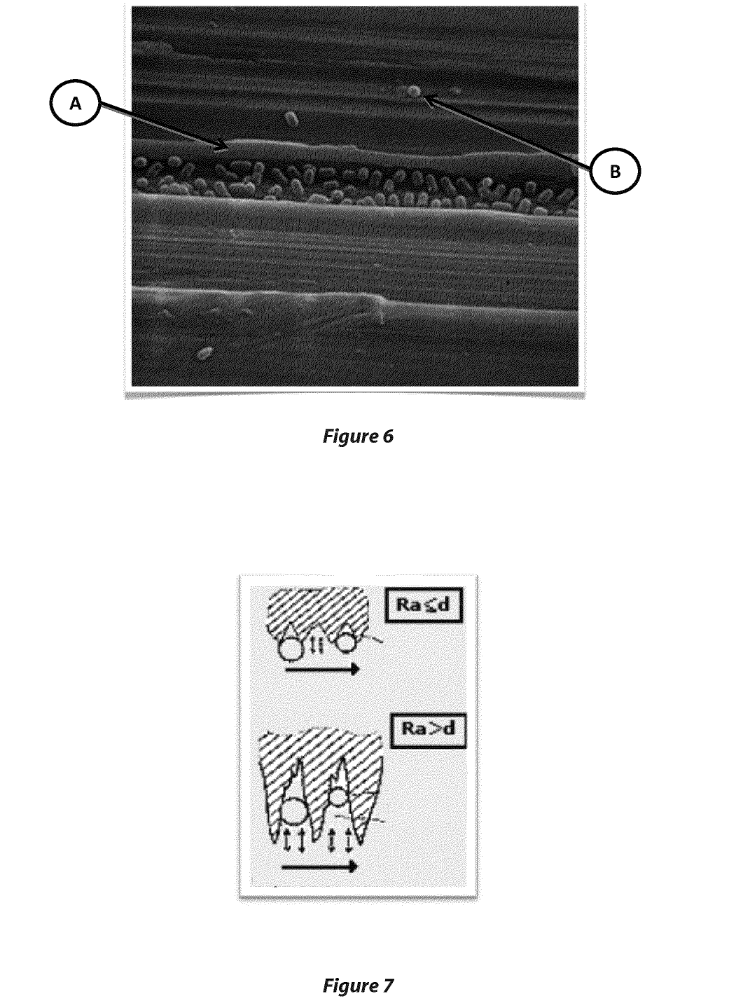

FIGS. 5, 6, and 7 show the effects of surface rugosity on bacteria dwelling and easy cleaning required for technical devices. In this context, FIG. 5 shows a diagram on how surface rugosity (Ra) is achieved for a L long surface where, in order to calculate Ra, absolute values of areas within the rugosity profile and the median line (X) are added, and then divided by the measurement length (L). It is the same as affirming that Ra is a L-basis rectangle height whose area is equal to those between the rugosity profile and the median line. FIG. 6 is a photograph obtained with a microscope, where adherence of Escherichia Coil bacteria (A) to a stainless steel (B) surface may be seen. Finally, FIG. 7 is a scheme of the relation between surface rugosity quality (Ra) and the size of the corresponding bacteria (d), which directly affects the said surface cleaning in order to make it bacteria-free.

This invention also includes a procedure to implement the invention system, with the following stages:
a) Wearing completely clean clothes by the pneumatic mechanical milking system handler. This shall include wearing gloves in both hands and mouth protection;
b) Before connecting the mechanical milking system, it is necessary to clean each dairy animal udder with clean disposable paper, avoiding to re-use it to clean the animal other udders and udders of other dairy animal;
c) Applying udder disinfectant;
d) After some minutes, cleaning each seal of the dairy animal udders with paper, which may contain disinfectant or aloe vera. Cleaning should be done as described in step b);
e) Installing the mechanical milking system (1) to the animal to be milked, placing at least one device (2) according to the embodiment of the invention;
f) Once the said udder milking is completed, and the pneumatic mechanical milking system (1) has been removed, an udder sealer should be applied in order to generate a physical barrier against infections until the next milking cycle.

As described earlier, the invention system, as well as the milking device (2), is used in milking systems in a traditional and/or organic dairy plant, where milked dairy animal may be cows, sheep, or goats. In the preferential embodiment of the invention they are preferably cows.

As an application example, this invention deals with milk safety reduction issues due to the presence of Infectious bacteria at the dairy plant, specifically in the milking room. The following are empiric results that show the invention qualities in the above described field, as well as in any other field that requires the characteristics herein described.

### Special Copper Alloy Plates Test and Exposure to S. Aureus ATCC 2123, Stage i and Stage ii, at Bioleche Laboratory, Los Angeles, Chile

In order to get more empiric evidence on the advantages of using the special alloy for surfaces exposed to bacteria causing mastitis, especially S. Aureus, and present in the milking room, the pneumatic mechanical milking system for a dairy animal, and in the milking device, results from experimental tests using the invention characteristics are presented below.

Results obtained shown the reduction, inhibition, and/or prevention of infection by mastitis thanks to the said alloy fungicide, anti-bacteria, and microbicide surface properties.

### ABSTRACT

The test was carried out at the microbiology department of Laboratorio Agroveterinarlo de Bioleche, Los Angeles, Chile, under quality standard ISO/IEC 17025:2005 and in compliance with standards ISO/TS 11133-2:2003 and ISO/TS 11133-1:2000 for the stationary stage calculation. S. Aureus subsp. aureus ATCC 25923 (Microbilogics Lot Num 360-93) stationary stage was calculated. The test was carried out in two stages, Part I: S. Aureus ATCC 25923 Feasiblity in Two Different Concentrations, Assessed at Different Copper Alloy Exposure Periods at 35° C. Part II: S. Aureus ATCC 25923 Feasiblity at a Concentration Assessed at Different Copper Alloy Exposure Periods at 22° C. It Is necessary to note that actual temperatures at milking farms were considered in the study. Both tests were based on ISO 22196/JIS Z 2801, with modifications.

### Part I

S. Aureus ATCC 25923 Feasiblity in Two Different Concentrations, Assessed at Different Copper Alloy Exposure Periods at 35° C.

### Material and Method

For this test, S. Aureus ATCC 25923 strains were used and kept at −70° C. They were placed at stationary stage, and then a representative aliquot (10 μl) was taken from two concentrations:
a) One, representative of the actual microbial load of milking equipment, 1000-10000 cfu/ml. (Amiot, J. 1991)
b) The other, representative of the actual microbial load at the dairy animal nipple output, a 500-1000 cfu/ml cow, specifically (Amiot, J. 1991).

Both concentrations were applied to 2.5×2.5 cm copper alloy plates, previously sterilized in autoclave; they were put inside a sterile Petri plate, covering the maximum of surface with 10 μl of the representative aliquot. Exposure periods were: 0 min, 20 min, 12 hours, and 24 hours, with incubation at 35° C. on culture stove (Memmert INE 500). After the exposure period, 15-18 ml Agar Plate-Count were dispensed and placed for incubation for 24 hours at 35° C. At the end of the incubation period, colonies were counted.

### Results

After 24 hours incubation at 35° C., the existing colonies were counted, including (+) and (−) controls for each concentration. It is necessary to note that 150 cfu/10 μl and 15 cfu/10 μl calculated concentrations, according to the stationary stage, were lower than the actual ones, 362 cfu/10 μl and 62 cfu/10 μl, respectively, whose results are shown in table 1.

TABLE 1

| | Initial | | | | | |
|---|---|---|---|---|---|---|
| | conc. | Initial | | | | |
| Time | 362 | conc. | Control (+) | Control (−) | Control (+) | Control (−) |
| a 35° C. | cfu/10 μl | 62 cfu/10 μl | 362 cfu/10 μl | 362 cfu/10 μl | 62 cfu/10 μl | 62 cfu/10 μl |
| 0 min | N/R | 42 | N/R | 0 | N/R | 0 |
| 20 min | 5 | N/R | N/R | 0 | N/R | 0 |
| 12 h | 0 | 0 | N/R | 0 | N/R | 0 |
| 24 h | 0 | 0 | 362 | 0 | 62 | 0 |

N/R = Not realized

### Part II

S. Aureus ATCC 25923 Feasibllty at a Concentration Assessed at Different Copper Alloy Exposure Periods at 22° C.

### Materials and Method

For this test, S. Aureus ATCC 25923 strains were used, kept at −70° C., placed at their stationary stage, and then a representative aliquot (10 μl) of the concentration was taken, representing the actual microbial load of milking equipment, 1000-10000 cfu/ml (Amiot, J. 1991).

This concentration was applied to 2.5×2.5 cm copper alloy plates, previously sterilized in autoclave; which were put inside a sterile Petri plate, covering the maximum of surface with 10 μl. Exposure periods were: 0 min, 15 min, 30 min, 45 min, 60 min, and 120 min, with incubation at 22° C. on culture stove (Memmert INR 400). After the exposure periods, 15-18 ml Agar Plate-Count were dispensed, and incubated for 24 hours at 35° C., after which colonies were counted.

### Results

After 24 hours incubation at 35° C., the existing colonies were counted, including (+) and (−) controls, for concentration. It is necessary to note that the 150 cfu/10 μl concentration calculated according to the stationary stage, was less than the actual 308 cfu/10 μl concentration. Results are shown in table 2.

TABLE 2

| Time | Initial conc. | Control (+) | Control (−) |
|---|---|---|---|
| a 22° C. | 308 cfu/10 μl | 308 cfu/10 μl | 308 cfu/10 μl |
| 0 min | 163 | N/R | 0 |
| 15 min | 106 | N/R | 0 |
| 30 min | 73 | N/R | 0 |
| 45 min | 17 | N/R | 0 |
| 60 min | 6 | N/R | 0 |
| 120 min | 2 | 308 | 0 |

N/R = Not realized

### CONCLUSION

When exposing the S. Aureus subsp. aurus ATCC 25923 strain to the 2.5×2.5 an copper alloy plates surface, we could see that counting decreases as of 0 min exposure in the Part I test: S. Aureus ATCC 25923 Feasibility in Two Different Concentrations, Assessed at Different Copper Alloy Exposure Periods at 35° C.; and for Part II test: S. Aureus ATCC 25923 Feasibility at a Concentration Assessed at Different Copper Alloy Exposure Periods at 22° C.

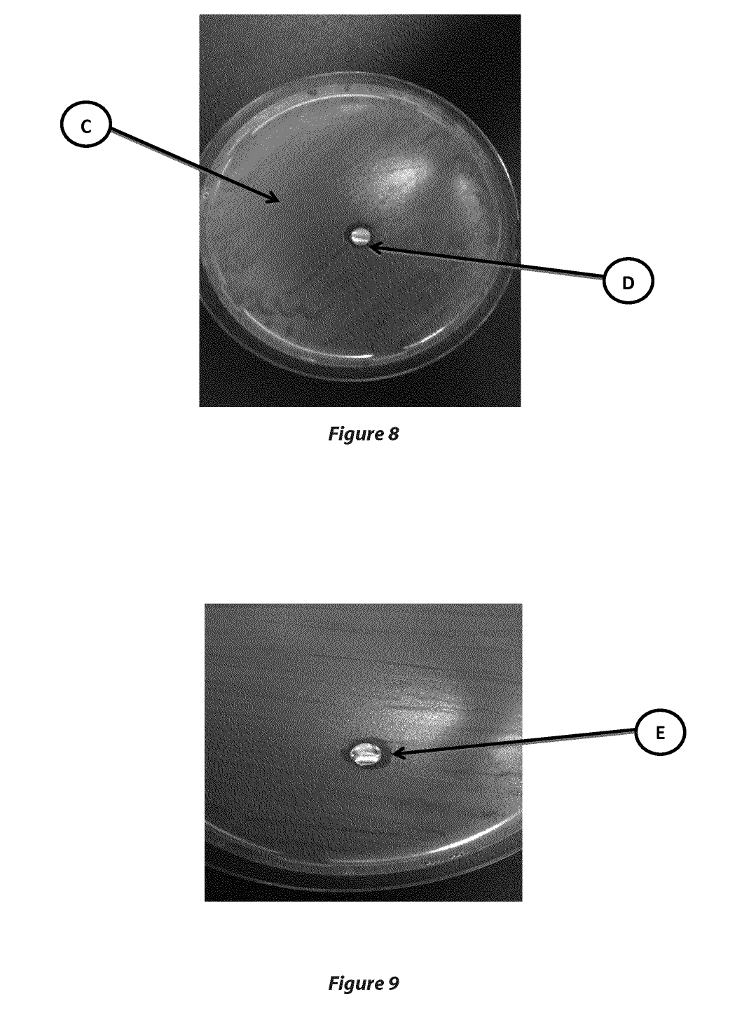

This may be noted in FIGS. 8 and 9, which show the application of the laboratory test carried out, where the Staphylococcus Aureus (C) bacteria was cultured on the entire plate surface, and where a small alloy disc used in the invention (D) was placed. The halo (E) formation around the alloy disc shows the power and effect generated by the alloy on the S. Aureus bacteria present in mastitis.

1. Pneumatic mechanical milking system (1) for a dairy animal that allows reducing, inhibiting, and/or preventing infection by mastitis, with fungicide, anti-bacteria, anti-virus, and microbicide surface properties, CHARACTERIZED in that of the system comprises:
at least one device (2) that connects the animal udder (3), that defines a cylindrical shape (4), where the said device defines different openings at its corresponding ends, an upper opening (5) of a larger diameter through which end the dairy animal udder is introduced, a lower end (6) with a smaller diameter, comparable to the upper end through which milk is extracted, and a lower angular end (7) of small diameter, formed by an expanded tubular section (8) connecting the system air supply, wherein said device (2) entire surface has a rugosity quality within a specific range and it Is formed by a special alloy containing at least 50% copper;
at least one extended membrane (9) in the sense of its main axis, with an upper end (10) with a lip (11) that externally fits into the device (2) upper opening (5), and a lower end (12) that goes through the device lower end (6) opening;
a milk collector (13) that includes a cover (14) provided with at least four entries (15, 16, 16, 17, 18), where at least one of the said entries connects with the expanded membrane lower end (12), wherein said cover also includes at least four air intakes (19, 20, 21, 22); the said collector and cover entire surface have a surface rugosity quality within a specific range, and the said surface is formed by a special alloy with at least 50% copper content;
at least one longitudinal connector (23) to channel air which, at the one end (24) connects the device (2) extended tubular section (8) and, on the other end (25), it connects a collector (13) air intake.

2. Pneumatic mechanical milking system (1) for a dairy animal, according to claim 1, CHARACTERIZED in that the device (2) surface is made of an alloy containing at least 50% copper, in addition to zinc, silicon, and phosphorous.

3. Pneumatic mechanical milking system (1) for a dairy animal, according to claim 2, CHARACTERIZED in that the fact that, when the alloy has at least 50% copper, combined with the rest of components, its surface has fungicide, and/or anti-bacteria, and/or anti-virus, and/or microbicide properties.

4. Pneumatic mechanical milking system (1) for a dairy animal, according to claim 1, CHARACTERIZED in that the device comprises a surface rugosity quality from 0.5 to 1 [μm].

5. Pneumatic mechanical milking system (1) for a dairy animal, according to claim 1, CHARACTERIZED in that the collector comprises a surface rugosity quality from 0.5 to 1 [μm].

6. Pneumatic mechanical milking system (1) for a dairy animal, according to claim 2, CHARACTERIZED in that the extended membrane (9) is formed of resilient material, which allows expanding and contracting its corresponding wall in front of mechanical requirements due to pressure differentials present at the air intake at the angular lower end (7).

7. Pneumatic mechanical milking system (1) for a dairy animal, according to claim 3, CHARACTERIZED in that the cover surface (14) is made of an alloy with at least 50% copper, in addition to zinc, silicon, and phosphorous.

8. Pneumatic mechanical milking system (1) for a dairy animal, according to claim 4, CHARACTERIZED in that the collector cover (13) comprises at each entry a configuration substantially tangential to the cover wall, with an inclination downwards.

9. Pneumatic mechanical milking system (1) for a dairy animal, according to claim 1, CHARACTERIZED in that the collector surface (13) is made of an alloy of at least 50% copper content, in addition to zinc, silicon, and phosphorous.

10. Pneumatic mechanical milking system (1) for a dairy animal, according to claim 7 and/or claim 9, CHARACTERIZED in that the fact that the alloy, having at least 50% copper content, combined with the rest of components, has a surface of fungicide, and/or anti-bacteria, and/or anti-virus, and/or microbicide characteristics.

11. Pneumatic mechanical milking system (1) for a dairy animal, according to claim 5, CHARACTERIZED in that the cover geometric configuration is frustoconical, with each entry located at a generally rectangular distribution.

12. Pneumatic mechanical milking system (1) for a dairy animal, according to claim 2, CHARACTERIZED in that the cylindrical device comprises a narrowed middle section.

13. Pneumatic mechanical milking system (1) for a dairy animal, according to claim 8, CHARACTERIZED in that the narrowing comprises a curvature radius from 8 to 10 [mm].

14. Pneumatic mechanical milking system (1) for a dairy animal, according to claim 8, CHARACTERIZED in that the narrowing comprises a curvature radius preferably from 8.5 to 9.5 [mm].

15. Pneumatic mechanical milking system (1) for a dairy animal, according to claim 8, CHARACTERIZED in that the narrowing comprises a curvature radius of 9.2 [mm], preferably.

16. Pneumatic mechanical milking system (1) for a dairy animal, according to claim 2, CHARACTERIZED in that the device lower end comprises a curvature radius from 8 to 12 [mm].

17. Pneumatic mechanical milking system (1) for a dairy animal, according to claim 2, CHARACTERIZED in that the device lower end preferably comprises a curvature radius from 9 to 11 [mm].

18. Pneumatic mechanical milking system (1) for a dairy animal, according to claim 2, CHARACTERIZED in that the device lower end preferably comprises a curvature radius of 10 [mm].

19. Pneumatic mechanical milking system (1) for a dairy animal, according to claim 2, CHARACTERIZED in that the device lower end preferably comprises a curvature radius of 10.5 [mm].

20. Pneumatic mechanical milking system (1) for a dairy animal, according to claim 2, CHARACTERIZED in that the device comprises a wall thickness of 1 to 2.5 [mm].

21. Pneumatic mechanical milking system (1) for a dairy animal, according to claim 2, CHARACTERIZED in that the device preferably comprises a wall thickness of 1.2 to 1.8 [mm].

22. Pneumatic mechanical milking system (1) for a dairy animal, according to claim 2, CHARACTERIZED in that the device preferably comprises a wall thickness of 1.2 [mm].

23. Pneumatic mechanical milking system (1) for a dairy animal, according to claim 2, CHARACTERIZED in that the device preferably comprises a wall thickness of 1.5 [mm].

24. Pneumatic mechanical milking system (1) for a dairy animal, according to claim 3, CHARACTERIZED in that the extended membrane comprises a cavity or lodge fitting in the lip entire perimeter, which allows a tight fitting in the device upper opening.

25. Pneumatic mechanical milking system (1) for a dairy animal, according to claim 20, CHARACTERIZED in that the extended membrane also comprises a notch ring proportional to the device lower opening diameter, wherein said configuration has a tight fit between the extended membrane and the device lower opening, which allows the membrane wall rigid fixing and enough surface stress as to generate the expansion and contraction effect during the dairy animal milking.

26. Pneumatic mechanical milking system (1) for a dairy animal, according to claim 1, CHARACTERIZED in that the device upper end comprises a lip or flange along its entire perimeter in order to facilitate fitting into the extended membrane lip.

27. Pneumatic mechanical milking system (1) for a dairy animal, according to claim 22, CHARACTERIZED in that said lip or flange is 3.5 to 5 [mm] long, with 1.8 to 2.5 [mm] curvature radius.

28. Pneumatic mechanical milking system (1) for a dairy animal, according to claim 22, CHARACTERIZED in that said lip or flange comprises a ribbed surface.

29. Pneumatic mechanical milking system (1) for a dairy animal, according to claim 1, CHARACTERIZED in that the device angular lower end is configured with a straight or curve extended tubular section.

30. Pneumatic mechanical milking system (1) for a dairy animal, according to claim 25, CHARACTERIZED in that the straight extended tubular section comprises 8 [mm] external diameter, 24.4 [mm] length, and 1.2 to 1.5 [mm] wall thickness.

31. Pneumatic mechanical milking system (1) for a dairy animal, according to claim 26, CHARACTERIZED in that the straight extended tubular section is, at its farthest end, 10 [mm] long, with 9 [mm] external diameter, wherein said straight extended tubular section includes a 25 degrees inclination angle with regard to the device main axis.

32. Pneumatic mechanical milking system (1) for a dairy animal, according to claim 25, CHARACTERIZED in that the straight extended tubular section is joined to the device body through 2 [mm] wide bead welding applied to the entire perimeter.

33. Pneumatic mechanical milking system (1) for a dairy animal, according to claim 25, CHARACTERIZED in that the extended tubular section comprises a curve of 25 to 30 [mm] curvature radius.

34. Pneumatic mechanical milking system (1) for a dairy animal, according to claim 29, CHARACTERIZED in that the extended tubular section comprises a curve which, in its farthest end, may be 10 [mm] long, with 9.4 [mm] external diameter, and the extended tubular section total length of 29 [mm], and 1.2 to 1.5 [mm] wall thickness.

35. Pneumatic mechanical milking system (1) for a dairy animal, according to claim 30, CHARACTERIZED in that the curve extended tubular section is joined to the device body through 2 [mm] wide bead welding applied to the entire perimeter.

36. Device (2) for a pneumatic mechanical milking system (1) for a dairy animal that allows reducing, inhibiting, and/or preventing infection by mastitis, with fungicide, anti-bacteria, anti-virus, and microbicide surface properties, CHARACTERIZED in that the device comprises a cylindrical geometry (4), wherein the said device defines different openings in its corresponding ends, and larger diameter upper opening (5) through which end the dairy animal udder is introduced, a lower end (6) with a smaller diameter opening, comparable to the upper end, through which milk is extracted, and an angular lower end (7) with a small diameter opening formed by an extended tubular section (8) through which the system air supply is connected, and where the said device (2) also includes an entire surface rugosity quality within a specific range, wherein said surface is formed by a special alloy with at least 50% copper content.

37. Device according to claim 36, CHARACTERIZED in that the device (2) surface formed by an alloy containing at least 50% copper, in addition to zinc, silicon, and phosphorus.

38. Device according to claim 37, CHARACTERIZED in that an alloy of at least 50% copper which, combined with the rest of components, presents a surface with fungicide, and/or anti-bacteria, and/or anti-virus, and/or microbicide properties.

39. Device according to claim 36, CHARACTERIZED in that it comprises a surface rugosity quality in the 0.5 to 1 [μm] range.

40. Device according to any of the previous claims, CHARACTERIZED in that it comprises a narrowed section in its cylindrical geometry.

41. Device according to claim 40, CHARACTERIZED in that the narrowing is located on the median section of its cylindrical geometry.

42. Device according to claims 40 or 41, CHARACTERIZED in that the narrowing comprises a curvature radius from 8 to 10 [mm].

43. Device according to claims 40 or 41, CHARACTERIZED in that the narrowing comprises a curvature between 8.5 and 9.5 [mm], preferably.

44. Device according to claims 40 or 41, CHARACTERIZED in that the narrowing comprises a preferable curvature radius of 9.2 [mm].

45. Device according to claim 36, CHARACTERIZED in that the device lower end comprises a curvature radius from 8 to 12 [mm].

46. Device according to claim 36, CHARACTERIZED in that the device lower end comprises a preferable curvature radius from 9 to 11 [mm].

47. Device according to claim 36, CHARACTERIZED in that the device lower end comprises a preferable curvature radius of 10 [mm].

48. Device according to claim 36, CHARACTERIZED in that the device lower end comprises a preferable curvature radius of 10.5 [mm].

49. Device according to claim 36, CHARACTERIZED in that the device comprises a wall thickness from 1 to 2.5 [mm].

50. Device according to claim 36, CHARACTERIZED in that the device comprises a preferable wall thickness from 12 to 1.8 [mm].

51. Device according to claim 36, CHARACTERIZED in that the device comprises a preferable wall thickness of 1.2 [mm].

52. Device according to claim 36, CHARACTERIZED in that the device comprises a preferable wall thickness of 1.5 [mm].

53. Device according to claim 36, CHARACTERIZED in that the device upper end comprises a lip or flange along its entire perimeter.

54. Device according to claim 53, CHARACTERIZED in that the said lip or flange is 3.5 to 5 [mm] long, with 1.8 to 2.5 [mm] curvature range.

55. Device according to claim 53, CHARACTERIZED in that the said lip or flange comprises a ribbed surface.

56. Device according to claim 36, CHARACTERIZED in that the device angular lower end is configured by a straight or curve extended tubular section.

57. Device according to claim 56, CHARACTERIZED in that the straight extended tubular section comprises an external diameter of 8 [mm], being 24.4 [mm] long, and a wall thickness from 1.2 to 1.5 [mm].

58. Device according to claim 56, CHARACTERIZED in that the straight extended tubular section farthest end is 10 [mm] long, with 9 [mm] external diameter, and 25 degree inclination angle with regard to the device main axis.

59. Device according to claim 56, CHARACTERIZED in that the straight extended tubular section is joined to the device body through 2 [mm] wide bead welding in the entire perimeter.

60. Device according to claim 56, CHARACTERIZED in that the extended tubular section comprises a curve with 25 to 30 [mm] curvature range.

61. Device according to claim 56, CHARACTERIZED in that the extended tubular section comprises a curve whose farthest end could be 10 [mm] long, with 9.4 [mm] external diameter, an extended tubular section total length of 29 [mm], and wall thickness from 1.2 to 1.5 [mm].

62. Device according to claim 56, CHARACTERIZED in that the curve extended tubular section is joined to the device body through 2 [mm] wide bead welding applied on the entire perimeter.

63. Device according to claim 36, CHARACTERIZED in that it comprises, a narrowing according to claim 41, a lower end according to claim 44, a wall thickness according to claim 48, a lip or flange dimensions according to claim 53, and an angular lower end where the extended tubular section is defined according to claims 56 and 57.

64. Procedure to implement a pneumatic mechanical milking system (1) for a dairy animal according to claim 1, CHARACTERIZED by the following steps:
a) wearing completely clean clothes by the pneumatic mechanical milking system handler, wherein this shall include wearing gloves in both hands and a mouth protector;
b) before connecting the mechanical milking system, it is necessary to clean each dairy animal udder with clean disposable paper, avoiding to re-use it to clean the animal other udders and udders of other dairy animals;
c) application of udder disinfectant;
d) after some minutes, clean each seal of the dairy animal udders with paper, which may contain disinfectant or aloe vera, wherein cleaning should be done as described in step b);
e) installing the mechanical milking system (1) to the animal to be milked, placing at least one device (2) of cylindrical geometry (4) to the dairy animal udder (4), where the said device defines different openings at its corresponding ends; a larger diameter higher opening (5) in which end the dairy animal udder is introduced; a small diameter lower end (6), compared to the upper end, through which milk is extracted; and an angular lower end (7) with a small diameter opening, where the said end is an extended tubular section (8) through which the system air supply is connected; wherein said device (2) entire surface has a rugosity quality within a specific range, and it is formed by a special alloy with at least 50% copper content;
f) once the said udder milking is completed, and the pneumatic mechanical milking system (1) has been removed, an udder sealer should be applied in order to generate a physical barrier against infections until the next milking cycle.

65. Use of a pneumatic mechanical milking system (1) for a dairy animal, according to claim 1, CHARACTERIZED by being used in traditional dairy plants milking systems.

66. Use of a pneumatic mechanical milking system (1), according to claim 65, CHARACTERIZED by the fact that milked dairy animals may be cows, sheep, or goats.

67. Use of a pneumatic mechanical milking system (1), according to claim 65, CHARACTERIZED by the fact that the milked dairy animal may be preferably a cow.

68. Use of a pneumatic mechanical milking system (1) for a dairy animal, according to claim 1, CHARACTERIZED by the fact that it is used in organic dairy plants milking systems.

69. Use of a pneumatic mechanical milking system (1), according to claim 68, CHARACTERIZED by the fact that milked dairy animals may be cows, sheep, or goats.

70. Use of a pneumatic mechanical milking system (1), according to claim 68, CHARACTERIZED by the fact that the milked dairy animal may be preferably a cow.

71. Use of a device (2) for a dairy animal, according to claim 36, CHARACTERIZED by the fact that it is used in traditional plants milking systems.

72. Use of a pneumatic mechanical milking system (1), according to claim 71, CHARACTERIZED by the fact that milked dairy animals may be cows, sheep, or goats.

73. Use of a pneumatic mechanical milking system (1), according to claim 71, CHARACTERIZED by the fact that the milked dairy animal may be preferably a cow.

74. Use of a device (2) for a dairy animal, according to claim 36, CHARACTERIZED by the fact that it is used in organic dairy plants milking systems.

75. Use of a pneumatic mechanical milking system (1), according to claim 74, CHARACTERIZED by the fact that milked dairy animals may be cows, sheep, or goat.

76. Use of a pneumatic mechanical milking system (1), according to claim 74, CHARACTERIZED by the fact that the milked dairy animal may be preferably a cow.
